(19) United States
(12) Patent Application Publication
(10) Pub. No.: US 2025/0184201 A1
(43) Pub. Date: Jun. 5, 2025

(54) METHODS AND APPARATUS OF DMRS SEQUENCE GENERATION

(71) Applicant: LENOVO (BEIJING) LIMITED, Beijing (CN)

(72) Inventors: Lingling Xiao, Beijing (CN); Bingchao Liu, Beijing (CN); Chenxi Zhu, Fairfax, VA (US); Wei Ling, Beijing (CN); Yi Zhang, Beijing (CN)

(21) Appl. No.: 18/842,462

(22) PCT Filed: Apr. 27, 2022
(86) PCT No.: PCT/CN2022/089534

§ 371 Date: Aug. 29, 2024

(51) Int. Cl. H04L 27/26; H04L 5/00

(52) U.S. Cl. CPC H04L 27/2613; H04L 5/0051

(57) ABSTRACT

Methods and apparatus of DMRS sequence generation are disclosed. The apparatus includes: a receiver that receives a configuration for Demodulation Reference Signal (DM-RS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; a processor that generates DMRS sequences for the first and second sets of DMRS ports.

### FIELD

The subject matter disclosed herein relates generally to wireless communication and more particularly relates to, but not limited to, methods and apparatus of DMRS sequence generation.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Physical Downlink Shared Channel (PDSCH), Physical Uplink Shared Channel (PUSCH), Bandwidth Part (BWP), Code-Division Multiplexing (CDM), Cyclic redundancy check (CRC), Downlink Control Information (DCI), Demodulation Reference Signal (DMRS, or DM-RS), Discrete Fourier Transform-spread-Orthogonal Frequency Division Multiplexing (DFT-s-OFDM), Frequency Division Orthogonal Cover Code (FD-OCC), Time Division Orthogonal Cover Code (TD-OCC), Cyclic Prefix Orthogonal Frequency Division Multiplexing (CP-OFDM), Frequency-Division Multiplexing (FDM), Index/Identifier (ID), Information Element (IE), Modulation Coding Scheme (MCS), Multiple Input Multiple Output (MIMO), Orthogonal Cover Code (OCC), Resource Block (RB), Resource Element (RE), Radio Network Temporary Identifier (RNTI), Transmission and Reception Point (TRP), Cell Radio Network Temporary Identifier (C-RNTI), Configured Scheduling RNTI (CS-RNTI), Discrete Fourier Transform (DFT), Frequency Range 1 (FR1), Frequency Range 2 (FR2), Peak-to-Average Power Ratio (PAPR), Pseudo-random Noise (PN), Technical Specification (TS), Configured Scheduling (CS).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

In Release 15, two types of demodulation reference signals (DMRS) are specified where DMRS type 1 includes 2 CDM groups, which supports up to 8 DMRS ports, and DMRS type 2 includes 3 CDM groups, which supports up to 12 DMRS ports. Throughout this disclosure, “DMRS type 1” may also be referred to as “type 1 DMRS”, and the terms may be used interchangeably. Similarly, “DMRS type 2” may also be referred to as “type 2 DMRS”.

The DMRS sequence of different DMRS ports within a CDM group is realized by a Pseudo-random Noise (PN) sequence multiplying a different FD-OCC and/or TD-OCC sequence. The DMRS sequence of DMRS ports among different CDM groups is the same PN sequence mapped on the different resource elements (REs). DMRS sequence generation in Release 15 may lead to high PAPR due to the repeated structure of the same sequence in the frequency domain on the same symbol. Then, in Release 16, low PAPR DMRS sequence is specified that different PN sequences are generated for different CDM groups.

With the increasing need for multiplexing capacity of downlink and uplink DMRS from various use cases, there is a need for increasing the number of orthogonal ports for DMRS. The potential methods to increase the number of DMRS ports may be in FDM or CDM manner. If FDM manner is used to increase the number of DMRS ports, and if the DMRS sequences of the additional DMRS ports are the same as legacy, then the PAPR is increased since the sequences of additional DMRS ports and legacy DMRS ports also constitute a repetition structure.

### SUMMARY

Methods and apparatus of DMRS sequence generation are disclosed.

According to a first aspect, there is provided an apparatus, including: a receiver that receives a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; a processor that generates DMRS sequences for the first and second sets of DMRS ports.

According to a second aspect, there is provided an apparatus, including: a transmitter that transmits a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; a processor that generates DMRS sequences for the first and second sets of DMRS ports.

According to a third aspect, there is provided a method, including: receiving, by a receiver, a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; generating, by a processor, DMRS sequences for the first and second sets of DMRS ports.

According to a fourth aspect, there is provided a method, including: transmitting, by a transmitter, a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; generating, by a processor, DMRS sequences for the first and second sets of DMRS ports.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic diagram illustrating an example of DMRS sequence for DMRS ports in different CDM groups for DMRS type 1 in accordance with some implementations of the present disclosure.

FIG. 4B is a schematic diagram illustrating an example of DMRS sequence for DMRS ports in different CDM groups for DMRS type 2 in accordance with some implementations of the present disclosure.

FIG. 5A is a schematic diagram illustrating an example of DMRS sequence for additional DMRS ports in different CDM groups in FDM manner for DMRS type 1 in accordance with some implementations of the present disclosure.

FIG. 5B is a schematic diagram illustrating an example of DMRS sequence for additional DMRS ports in different CDM groups in FDM manner for DMRS type 2 in accordance with some implementations of the present disclosure.

FIG. 6A is a schematic diagram illustrating an example of different DMRS sequences generated for the additional DMRS ports and legacy DMRS ports for DMRS type 1 in accordance with some implementations of the present disclosure.

FIG. 6B is a schematic diagram illustrating an example of different DMRS sequences are generated for the additional DMRS ports and legacy DMRS ports for DMRS type 2 in accordance with some implementations of the present disclosure.

FIG. 7A is a schematic diagram illustrating an example of a long DMRS sequence for the additional DMRS ports and legacy DMRS ports within a CDM group for DMRS type 1 in accordance with some implementations of the present disclosure.

FIG. 7B is a schematic diagram illustrating an example of a long DMRS sequence for the additional DMRS ports and legacy DMRS ports within a CDM group for DMRS type 2 in accordance with some implementations of the present disclosure.

FIG. 8 is a flow chart illustrating steps of DMRS sequence generation by UE in accordance with some implementations of the present disclosure; and

FIG. 9 is a flow chart illustrating steps of DMRS sequence generation by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

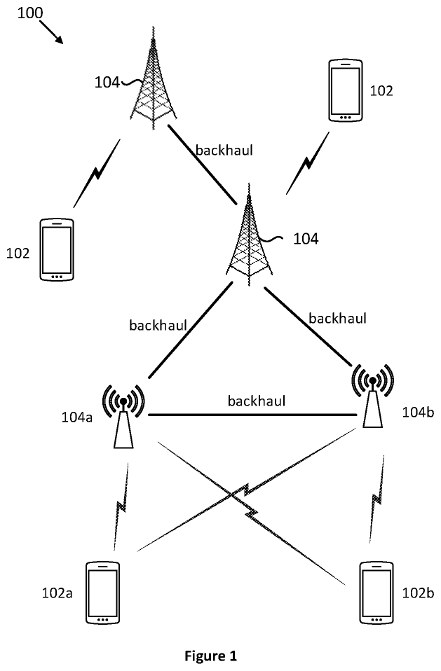

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the downlink (DL) and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

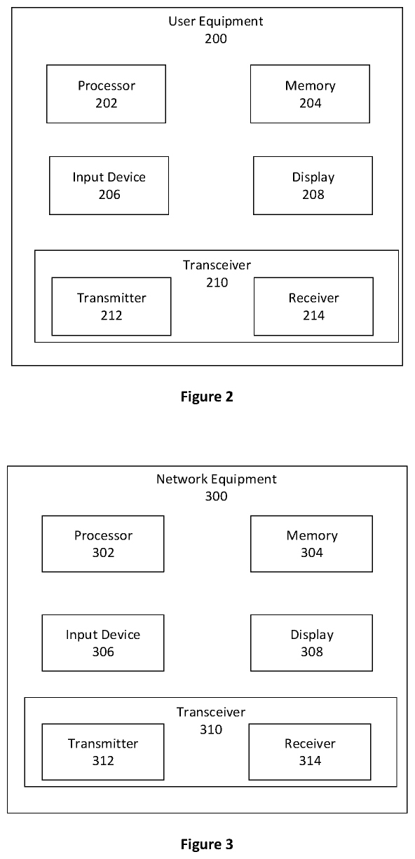

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

In Release 15, the DMRS sequence for PUSCH with CP-OFDM (i.e., transform precoding of the PUSCH transmission is disabled) and DMRS mapping is specified in TS 38.211. The same principle is applicable to DMRS for PDSCH.

The following is an extract from TS 38.211 relating to sequence generation when transform precoding is disabled.

If transform precoding for PUSCH is not enabled, the sequence r(n) shall be generated according to

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1. The pseudo-random sequence generator shall be initialized with

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot, n_{s,f}^{μ} is the slot number within a frame, and

N_{ID}⁰, N_{ID}¹ ∈ {0,1, . . . ,65535} are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a configured grant;

N_{ID}⁰ ∈ {0,1, . . . ,65535} is given by the higher-layer parameter scramblingID0 in the DMRS-UplinkConfig IE if provided and the PUSCH is scheduled by DCI format 0_0 with the CRC scrambled by C-RNTI, MCS-C-RNTI, or CS-RNTI;

N_{ID}⁰, N_{ID}¹ {0,1, . . . ,65535} are, for each msgA PUSCH configuration, given by the higher-layer parameters msgA-ScramblingID0 and msgA-ScramblingID1, respectively, in the msgA-DMRS-Config IE if provided and the PUSCH transmission is triggered by a Type-2 random access procedure as described in clause 8.1A of [5, TS 38.213];

$${N}_{ID}^{{\overline{n}}_{SCID}^{\overline{λ}}} = {N}_{ID}^{cell}$$

otherwise;

n̅_{SCID}^{λ̅} and λ̅ are given by
if the higher-layer parameter dmrs-Uplink in the DMRS-UplinkConfig IE is provided

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where λ is the CDM group defined in clause 6.4.1.1.3.
otherwise

$${\overline{n}}_{SCID}^{\overline{λ}} = {n}_{SCID}$$

$$\overline{λ} = 0$$

The quantity n_{SCID} ∈ {0,1} is

indicated by the DM-RS initialization field, if present, either in the DCI associated with the PUSCH transmission if DCI format 0_1 or 0_2, in [4, TS 38.212] is used;

indicated by the higher layer parameter dmrs-SeqInitialization, if present, for a Type 1 PUSCH transmission with a configured grant;

determined by the mapping between preamble(s) and a PUSCH occasion and the associated DMRS resource for a PUSCH transmission of Type-2 random access process in [5, TS 38.213];

otherwise n_{SCID}=0.

The following is an extract from TS 38.211 relating to precoding and mapping to physical resources.

The sequence r(m) shall be mapped to the intermediate quantity ã_{k,l}^{(\tilde{p}}^{_{j,}}^{μ)} according to

if transform precoding is not enabled,

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , υ - 1$$

where w_{f}(k′), wₜ(l′), and Δ are given by Tables 6.4.1.1.3-1 and 6.4.1.1.3-2 and the configuration type is given by the higher-layer parameter DMRS-UplinkConfig, and both k′ and Δ correspond to \tilde{p}₀, . . . , \tilde{p}_{ν-1}. The intermediate quantity ã_{k,l}^{(\tilde{p}}^{_{j,}}^{μ)}=0 if Δ corresponds to any other antenna ports than \tilde{p}ⱼ.
The intermediate quantity ã_{k,l}^{(\tilde{p}}^{_{j,}}^{μ)} shall be precoded, multiplied with the amplitude scaling factor β_{PUSCH}^{DMRS} in order to conform to the transmit power specified in [6, TS 38.214], and mapped to physical resources according to

$$[ \begin{matrix}{a}_{k , l}^{{p}_{0} , μ} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {\tilde{p}}_{0} , μ )} \\ ⋮ \\ {\tilde{a}}_{k , l}^{( {\tilde{p}}_{υ - 1} , μ )}\end{matrix} ]$$

where

the precoding matrix W is given by clause 6.3.1.5,

the set of antenna ports {p₀, . . . , p_{ρ-1}} is given by clause 6.3.1.5, and

the set of antenna ports {\tilde{p}₀, . . . , \tilde{p}_{ν-1}} is given by [6, TS 38.214];

and the following conditions are fulfilled:

the resource elements ã_{k,l}^{(\tilde{p}}^{_{j,}}^{μ)} are within the common resource blocks allocated for PUSCH transmission.

The reference point for k is

subcarrier 0 in common resource block 0 if transform precoding is not enabled, and

subcarrier 0 of the lowest-numbered resource block of the scheduled PUSCH allocation if transform precoding is enabled.

The reference point for l and the position l₀ of the first DM-RS symbol depends on the mapping type:

for PUSCH mapping type A:
l is defined relative to the start of the slot if frequency hopping is disabled and relative to the start of each hop in case frequency hopping is enabled
l₀ is given by the higher-layer parameter dmrs-TypeA-Position

for PUSCH mapping type B:
l is defined relative to the start of the scheduled PUSCH resources if frequency hopping is disabled and relative to the start of each hop in case frequency hopping is enabled
l₀=0

TABLE 6.4.1.1.3-1
Parameters for PUSCH DM-RS configuration type 1.

| | | |
|---|---|---|
| CDM | w_{f} (k′) | wₜ (l′) |

| \tilde{p} | group λ | Δ | k′ = 0 | k′ = 1 | p | group λ |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 6.4.1.1.3-2
Parameters for PUSCH DM-RS configuration type 2.

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

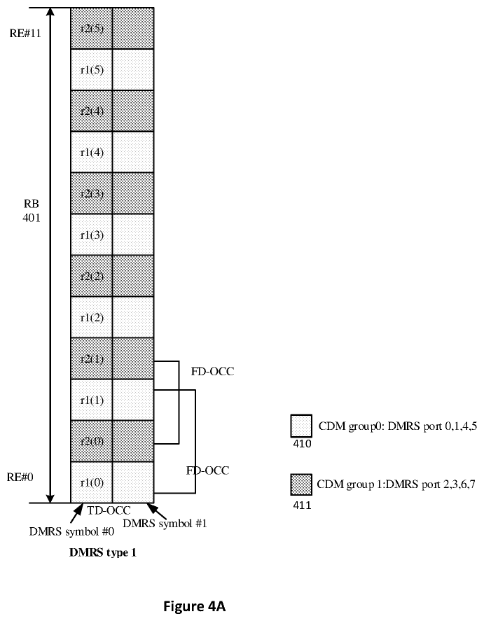

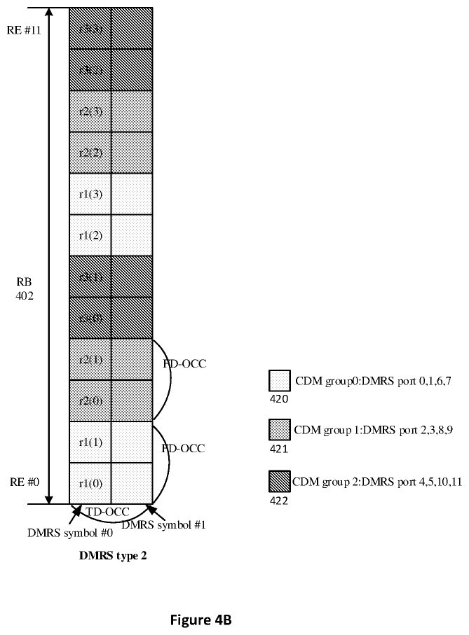

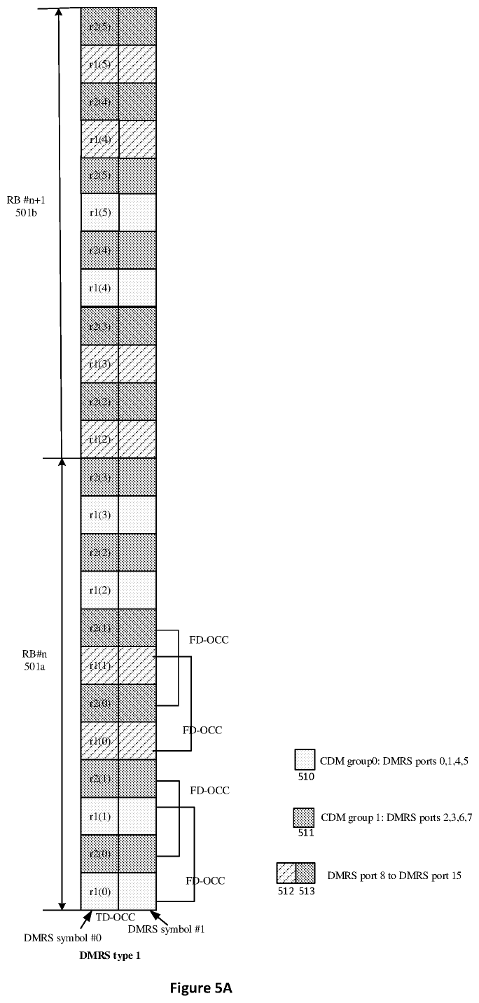

In Release 15, two DMRS types are specified. DMRS type 1 includes 2 CDM groups, which supports up to 8 DMRS ports, and DMRS type 2 includes 3 CDM groups, which supports up to 12 DMRS ports. A CDM group includes a number of DMRS ports which are quasi co-located with respect to Doppler shift, Doppler spread, average delay, delay spread, and spatial Rx (when applicable). FIGS. 4A and 4B are schematic diagrams illustrating examples of DMRS sequences for DMRS ports in different CDM groups in an RB for DMRS type 1 and DMRS type 2, respectively. For DMRS type 1, as shown in FIG. 4A, for a DMRS symbol (e.g., DMRS symbol #0), each DMRS port occupies 6 REs (e.g., r1(0), r1(1), . . . r1(5)) in each scheduled RB (e.g., RB 401). Thus, the length of DMRS sequence of each DMRS port in an RB is 6, and the DMRS sequence is denoted as r1(0) to r1(5), and r2(0) to r2(5) for DMRS ports in CDM group 0 and CDM group 1 respectively. If the number of scheduled RBs of a PDSCH or a PUSCH transmission is N, the length of DMRS sequence of each DMRS port is 6*N. For DMRS type 2, as shown in FIG. 4B, for a DMRS symbol (e.g., DMRS symbol #0), each DMRS port occupies 4 REs (e.g., r1(0), r1(1), r1(2), r1(3)) in each scheduled RB (e.g., RB 402), and thus the length of DMRS sequence of each DMRS port in an RB is 4, and the DMRS sequence is denoted as r1(0) to r1(3), r2(0) to r2(3), and r3(0) to r3(3) for DMRS ports in CDM group 0, CDM group 1 and CDM group 2 respectively.

DMRS sequences of different DMRS ports within a CDM group are achieved by multiplying a FD-OCC sequence and/or a TD-OCC sequence to a same DMRS sequence r. In Release 15, a same DMRS sequence r is adopted for different CDM groups. In Release 16, if low PAPR is configured, different DMRS sequence r1, r2, and r3 are adopted for different CDM groups and these different sequences may reduce or eliminate the repetition structure in frequency domain as in Release 15.

In Release 18 MIMO, there is a need for increasing the DMRS port without increasing the DM-RS overhead. In such cases, FDM may be used where the additional DMRS ports and legacy DMRS ports are mapped to different REs. Methods of generating low PAPR DMRS sequences of the additional DMRS ports realized by FDM are proposed when low PAPR DMRS is configured.

Based on Release 15, 16 and 17 of 3GPP specifications, up to 8 orthogonal DMRS ports are supported for type 1 DMRS (e.g., type 1 DMRS ports 0-7), and up to 12 orthogonal DMRS ports (e.g., type 2 DMRS ports 0-11) are supported for type 2 DMRS. According to the requirement for increasing DMRS ports in Release 18, a maximum of 16 or 24 DMRS ports may be supported for type 1 DMRS and type 2 DMRS, respectively, i.e., the legacy DMRS ports 0-7 and the newly introduced additional DMRS ports 8-15 for type 1 DMRS, and the legacy DMRS ports 0-11 and the newly introduced additional DMRS ports 12-23 for type 2 DMRS.

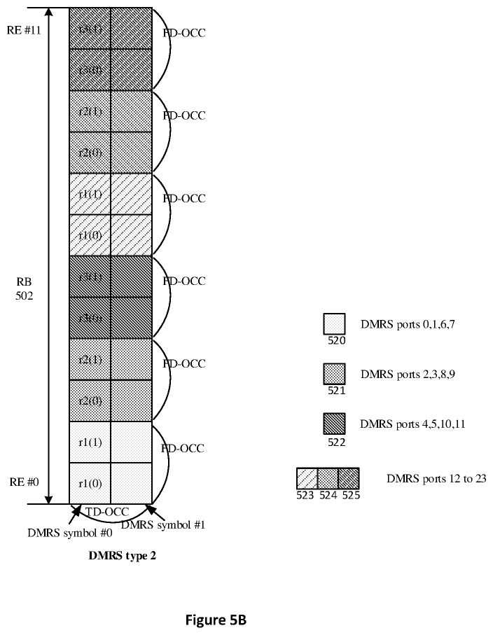

FIGS. 5A and 5B are schematic diagrams illustrating examples of DMRS sequences for additional DMRS ports in different CDM groups in FDM manner for DMRS type 1 and DMRS type 2, respectively. As shown in FIGS. 5A and 5B, the additional DMRS ports (e.g., DMRS ports 8-15 in FIG. 5A, and DMRS ports 11-23 in FIG. 5B) are achieved by FDM manner and the number of REs occupied by each DMRS port is halved, as compared to FIGS. 4A and 4B. The legacy DMRS ports are mapped to the REs in solid shade (e.g., 510, 511, 520, 521, 522) and the additional DMRS ports are mapped to the REs with line patterns (e.g., 512, 513, 523, 524, 525).

If the DMRS sequences of the additional DMRS ports are generated according to the legacy rule, it may cause high PAPR issue. For example, the two scheduled DMRS ports are mapped to REs 510 and REs 512 (or REs 520 and REs 523), respectively, which may lead to construction of a repetition structure in the frequency domain. Several schemes are proposed for generating low PAPR DMRS sequences.

For sequence generation, one approach is that different DMRS sequences are generated for the additional DMRS ports and the legacy DMRS ports.

In a first scheme, two different DMRS sequences are generated for DMRS ports within one CDM group. This scheme is based on the assumption that no new CDM group is introduced with the additional DMRS ports, and the mapping between DMRS ports and CDM groups is provided in Table 1 below.

TABLE 1
Mapping between DMRS ports and CDM groups
without introducing new CDM group

| DMRS type | CDM group λ | DMRS port index |
|---|---|---|
| DMRS type 1 | 0 | 0, 1, 4, 5, 8, 9, 12, 13 |
| | 1 | 2, 3, 6, 7, 10, 11, 14, 15 |
| DMRS type 2 | 0 | 0, 1, 6, 7, 12, 13, 18, 19 |
| | 1 | 2, 3, 8, 9, 14, 15, 20, 21 |
| | 2 | 4, 5, 10, 11, 16, 17, 22, 23 |

In Table 1, the additional DMRS ports are in bold while the other DMRS ports are the legacy ports.

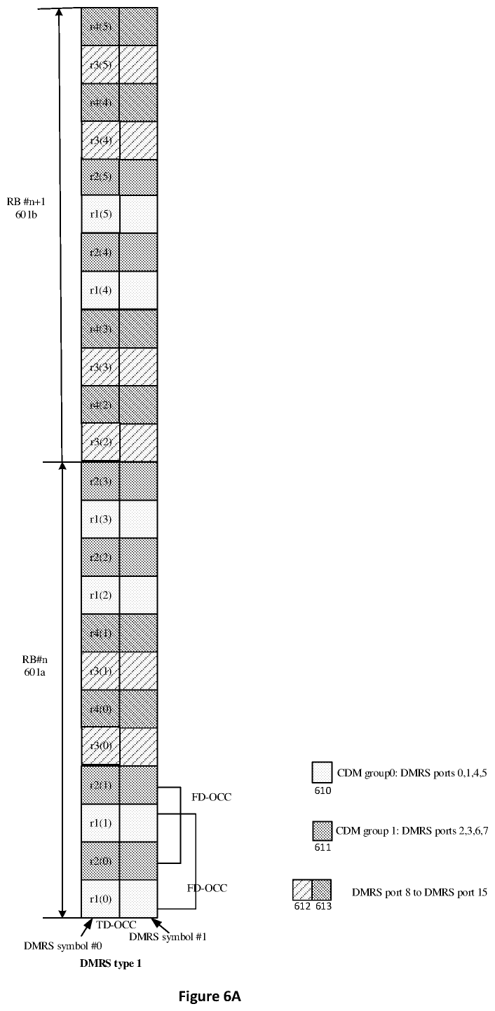

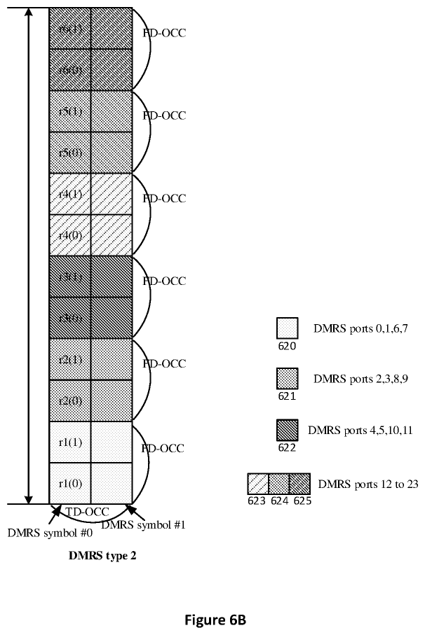

FIGS. 6A and 6B are schematic diagrams illustrating examples of different DMRS sequences generated for the additional DMRS ports and legacy DMRS ports for DMRS type 1 and DMRS type 2, respectively, in accordance with some implementations of the present disclosure. As shown in FIG. 6A, for DMRS type 1, the additional DMRS ports 8, 9, 12, 13 are mapped to REs 612 and the additional DMRS ports 10, 11, 14, 15 are mapped to REs 613. As shown in FIG. 6B, for DMRS type 2, the additional DMRS ports 12, 13, 18, 19 are mapped to REs 623, the additional DMRS ports 14, 15, 20, 21 are mapped to REs 624, and the additional DMRS ports 16, 17, 22, 23 are mapped to REs 625.

In this scheme, DMRS ports mapped to REs of the same grey level as shown in FIGS. 6A and 6B (e.g., REs 610 and REs 612 are of the same grey level) are within one CDM group. DMRS type 1 includes two CDM groups and DMRS type 2 includes three CDM groups, which is the same as that in Release 16, while the number of DMRS ports within a same CDM group is doubled compared to Release 16.

The UE may include a receiver that receives a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; a processor that generates DMRS sequences for the first and second sets of DMRS ports. The receiver may further receive a configuration for enabling low Peak-to-Average Power Ratio (PAPR) DMRS sequence.

If low PAPR is configured, two different DMRS sequences need to be generated for each CDM group, that is, one DMRS sequence is generated for the legacy DMRS ports mapped to REs in solid (e.g., 610, 611, 620, 621, 622) and another DMRS sequence is generated for the additional DMRS ports mapped to REs with line patterns (e.g., 612, 613, 623, 624, 625).

The DMRS sequence is a PN sequence and the initialization value, hereby denoted as cᵢₙᵢₜ, for each DMRS port may be determined based on the following formula:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} + δ * {2}^{m} ) mod {2}^{31}$$

The meaning of the variables in the formula are the same as the legacy as specified in TS 38.211. For the legacy DMRS ports in a CDM group, the newly added δ is zero, i.e., δ=0, and for the additional DMRS ports in the same CDM group, δ=1 and m is an integer no less than 0.

In this scheme, the first set of DMRS ports (e.g. DMRS ports 0-7) are from a first set of Code-Division Multiplexing (CDM) groups (e.g. CDM groups 0-1), and the second set of DMRS ports are grouped into the first set of CDM groups (i.e. CDM groups 0-1) as well. The processor generates two DMRS sequences for each CDM group in the first set of CDM groups, e.g. one for CDM group 0 and another for CDM group 1. The two DMRS sequences for a CDM group may comprise: a first DMRS sequence, based on a first initialization value (e.g. where δ=0), for the first set of DMRS ports within the CDM group; and a second DMRS sequence, based on a second initialization value (e.g. where δ=1), for the second set of DMRS ports within the CDM group. The first initialization value is derived based on a predefined formula, and the second initialization value is derived based on the predefined formula with an offset value.

For DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15. For DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

In a second scheme, the additional DMRS ports with TD-OCC and FD-OCC are grouped into new CDM groups.

This scheme is based on the assumption that additional new CDM groups are introduced for the additional DMRS ports, and the mapping between DMRS ports and CDM groups are provided in Table 2 below.

TABLE 2
Mapping between DMRS ports and
CDM groups with new CDM groups

| DMRS type | CDM group λ | DMRS port index |
|---|---|---|
| DMRS type 1 | 0 | 0, 1, 4, 5 |
| | 1 | 2, 3, 6, 7 |
| | 2 | 8, 9, 12, 13 |
| | 3 | 10, 11, 14, 15 |
| DMRS type 2 | 0 | 0, 1, 6, 7 |
| | 1 | 2, 3, 8, 9 |
| | 2 | 4, 5, 10, 11 |
| | 3 | 12, 13, 18, 19 |
| | 4 | 14, 15, 20, 21 |
| | 5 | 16, 17, 22, 23 |

In Table 2, the additional DMRS ports are in bold while the other DMRS ports are the legacy ports.

The mapping between DMRS ports and CDM groups in Table 2 may also be illustrated with reference to FIGS. 6A and 6B. For DMRS type 1, CDM group 2 and CDM group 3 are introduced. CDM group 2 includes the additional DMRS ports 8, 9, 12, 13 mapped to REs 612 and CDM group 3 includes the additional DMRS ports 10, 11, 14, 15 mapped to REs 613 as shown in FIG. 6A. For DMRS type 2, CDM group 3, CDM group 4 and CDM group 5 are introduced. CDM group 3 includes the additional DMRS ports 12, 13, 18, 19 mapped to REs 623, CDM group 4 includes the additional DMRS ports 14, 15, 20, 21 mapped to REs 624 and CDM group 5 includes the additional DMRS ports 16, 17, 22, 23 mapped to REs 625 as shown in FIG. 6B.

In this scheme, the first set of DMRS ports (e.g. DMRS ports 0-7) are from a first set of CDM groups (e.g. CDM groups 0-1), and the second set of DMRS ports (e.g. DMRS ports 8-15) are grouped into a second set of CDM groups (e.g. CDM groups 2-3); and the processor generates an additional DMRS sequence for each CDM group in the second set of CDM groups, different from a corresponding DMRS sequence in the first set of CDM groups. As shown in Table 2, for type 1 DMRS, the second set of CDM groups comprises CDM group 2 and CDM group 3; CDM group 2 includes DMRS ports 8, 9, 12, 13; and CDM group 3 includes DMRS ports 10, 11, 14, 15. For type 2 DMRS, the second set of CDM groups comprises CDM group 3, CDM group 4, and CDM group 5; CDM group 3 includes DMRS ports 12, 13, 18, 19; CDM group 4 includes DMRS ports 14, 15, 20, 21; and CDM group 5 includes DMRS ports 16, 17, 22, 23.

In this example, DMRS ports mapped to the REs of the same grey level but different patterns shown in FIGS. 6A and 6B are denoted as among different CDM groups (e.g., REs 610 and REs 612 are of different CDM groups). That is, for DMRS type 1, the DMRS ports mapped to REs 610 constitute a CDM group 0 as in Release 15, and DMRS ports mapped to REs 612 constitute another CDM, for example CDM group 2. Similarly, the DMRS ports mapped to REs 611 constitute a CDM group 1 as in Release 15, and DMRS ports mapped to REs 613 constitute another CDM group, for example CMD group 3. The same is applicable to DMRS type 2. Thus, DMRS type 1 may include four CDM groups and DMRS type 2 may include six CDM groups.

Then, the cᵢₙᵢₜ of DMRS sequence can use the same formula as in Release 16:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where the λ=λ, and λ is the CDM group index. In this scheme, CDM group index can be 0, 1, 2, 3 for DMRS type 1 and CDM group index can be 0, 1, 2, 3, 4, 5 for DMRS type 2, and

$${\overline{n}}_{SCID}^{\overline{λ}} = \{ \begin{matrix}{n}_{SCID} & λ = 0 or λ = 2 or λ = 4 \\ 1 - {n}_{SCID} & λ = 1 or λ = 3 or λ = 5\end{matrix}$$

$$\overline{λ} = λ$$

For the above two schemes, since the length of DMRS sequence of a DMRS port is halved compared to that of a DMRS port in Release 15, the DMRS sequence of a DMRS port needs to be mapped to REs with additional DMRS ports, then the following formula can be used:

$${a}_{k , l}^{( p , μ )} = {w}_{f} ( {k}^{′} ) {w}_{t} ( {l}^{′} ) r ( 2 n + {k}^{′} )$$

$$k = \{ \begin{matrix}8 n + 2 {k}^{′} + Δ & Configuration type 1 \\ 12 n + {k}^{′} + Δ & Configuration type 2\end{matrix}$$

$${k}^{′} = 0 , 1$$

$$l = \overline{l} + {l}^{′}$$

$$n = 0 , 1 , …$$

Since for each DMRS port, the number of REs occupied by each DMRS port is halved, 8n and 12n for DMRS type 1 and DMRS type 2 are used to replace the original 4n and 6n, respectively, in the formula. For the additional DMRS ports mapped to the REs with line patterns 612 and 613 shown in FIG. 6A, Δ may be 4and 5, respectively, for DMRS type 1. For the additional DMRS ports mapped to REs with line patterns 623, 624 and 625 shown in FIG. 6B, 4 may be 6, 8 and 10, respectively, for DMRS type 2.

The value of Δ for each DMRS port p is provided in Table 3 and Table 4 for DMRS type 1 and type 2, respectively, where Δ in bold are for the additional DMRS ports.

TABLE 3
Δ value for each DMRS port for DMRS type 1

| p | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| Δ | 0 | 0 | 1 | 1 | 0 | 0 | 1 | 1 | 4 | 4 | 5 | 5 | 4 | 4 | 5 | 5 |

TABLE 4
Δ value for each DMRS port for DMRS type 2

| p | 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 |
|---|---|---|---|---|---|---|---|---|---|---|---|---|---|---|---|---|---|---|---|---|---|---|---|---|
| Δ | 0 | 0 | 2 | 2 | 4 | 4 | 0 | 0 | 2 | 2 | 4 | 4 | 6 | 6 | 8 | 8 | 10 | 10 | 6 | 6 | 8 | 8 | 10 | 10 |

In one example, a DCI format 0_1 schedules a PUSCH transmission and the DMRS is type 1, and in Release 18, FDM manner is used to increase the number of DMRS ports and the number of DMRS ports for DMRS type 1 is 16, as shown in FIG. 6A and Table 1 or 2. DMRS ports 0, 1, 4, 5 are mapped to REs 610, and the additional DMRS ports 8, 9, 12, 13 are mapped to REs 612. Suppose DCI indicates n_{SCID} to be 0 and indicates DMRS port 0 and DMRS port 8 for the PUSCH transmission, then if the first scheme without new CDM groups introduced is used and δ=1 and m=0 for the additional DMRS ports, cᵢₙᵢₜ of different DMRS sequences for DMRS port 0 and DMRS port 8 are cᵢₙᵢₜ₁ and cᵢₙᵢₜ₂ respectively,

$${c}_{init 1} = ( {2}^{17} ( {N}_{s y m b}^{slot} {n}_{s , f}^{μ} + l + 1 ) ( 2 {N}_{ID}^{0} + 1 ) + 0 + 2 {N}_{ID}^{0} + 0 + 0 ) mod {2}^{31}$$

$${c}_{init 2} = ( {2}^{17} ( {N}_{symb}^{slot} {n}_{s , f}^{μ} + l + 1 ) ( 2 {N}_{ID}^{0} + 1 ) + 0 + 2 {N}_{ID}^{0} + 0 + 1 ) mod {2}^{31}$$

and if the second scheme with new CDM groups introduced is used, the additional DMRS ports 8, 9, 12, 13 are included in CDM group 2, cᵢₙᵢₜ of different DMRS sequences for DMRS port 0 and DMRS port 8 are cᵢₙᵢₜ₁ and cᵢₙᵢₜ₂ respectively,

$${c}_{init 1} = ( {2}^{17} ( {N}_{symb}^{slot} {n}_{s , f}^{μ} + l + 1 ) ( 2 {N}_{ID}^{0} + 1 ) + 0 + 2 {N}_{ID}^{0} + 0 ) mod {2}^{31}$$

$${c}_{init 2} = ( {2}^{17} ( {N}_{symb}^{slot} {n}_{s , f}^{μ} + l + 1 ) ( 2 {N}_{ID}^{0} + 1 ) + {2}^{17} + 2 {N}_{ID}^{0} + 0 ) mod {2}^{31}$$

In some other examples, a different approach may be used for generating low PAPR DMRS sequences. A long DMRS sequence is generated for each CDM group, including the additional DMRS ports and the legacy DMRS ports within a same CDM group.

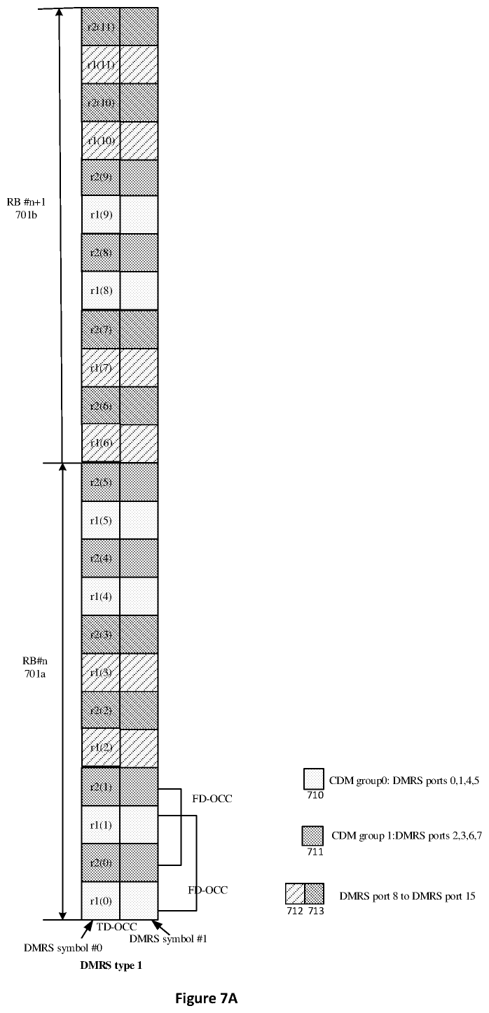

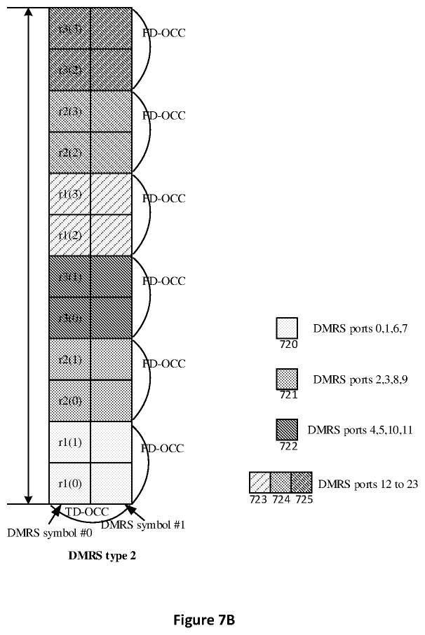

In one example, similar to the first scheme, no additional or new CDM groups are introduced. FIGS. 7A and 7B are schematic diagrams illustrating examples of a long DMRS sequence for the additional DMRS ports and legacy DMRS ports within a CDM group for DMRS type 1 and DMRS type 2, respectively. DMRS mapped to REs of the same grey level as shown in FIGS. 7A and 7B (e.g., REs 710 and 712, or REs 720 and 723) are within one CDM group, i.e., DMRS type 1 includes two CDM groups and DMRS type 2 includes three CDM groups, the same as in Release 16. The mapping between DMRS ports and CDM groups are the same as specified in Table 1. Even though the number of REs in each RB occupied by each DMRS port is halved, the length of DMRS sequence is not halved.

A long DMRS sequence for each CDM group may be generated same as in Release 16 and the long sequence may be shared by the legacy DMRS ports and the additional DMRS ports within a CDM group.

For example, for DMRS type 1 as shown in FIG. 7A, DMRS ports mapped to REs 710 and REs 712 correspond to different parts of a same long DMRS sequence which is doubled as the number of REs occupied by each DMRS port.

For mapping the DMRS sequence of a DMRS port to REs, since the additional DMRS ports and legacy DMRS ports correspond to different parts of a long sequence, the formula can be changed as:

$${a}_{k , l )}^{( p , μ )} = {w}_{f} ( {k}^{′} ) {w}_{t} ( {l}^{′} ) r ( 4 n + {k}^{′} + α ) \qquad ( 1 )$$

$$Or {a}_{k , l}^{( p , μ )} = {w}_{f} ( {k}^{′} ) {w}_{t} ( {l}^{′} ) r ( 4 n + {k}^{′} + 2 α ) \qquad ( 2 )$$

$$where ,$$

$$k = \{ \begin{matrix}8 n + 2 {k}^{′} + Δ & Configuration type 1 \\ 12 n + {k}^{′} + Δ & Configuration type 2\end{matrix}$$

$${k}^{′} = 0 , 1$$

$$l = \overline{l} + {l}^{′}$$

$$n = 0 , 1 , …$$

where α is the start position of the sequence of a DMRS port, that is, for legacy DMRS ports (i.e., DMRS port 0 to DMRS port 7 for DMRS type 1, and DMRS port 0 to DMRS port 11 for DMRS type 2), α=0, for the additional DMRS ports (i.e., DMRS port 8 to DMRS port 15 for DMRS type 1, and DMRS port 12 to DMRS port 23 for DMRS type 2), α=2 if formula (1) is used and α=1 if formula (2) is used. Other variables are the same as those in the previous approach.

In this approach, the first set of DMRS ports are from a first set of CDM groups, and the second set of DMRS ports are grouped into the first set of CDM groups; and the processor generates one sequence r(m) for all DMRS ports in each CDM group in the first set of CDM groups, where m is a list of nonnegative integers starting from zero. For DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15. For DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

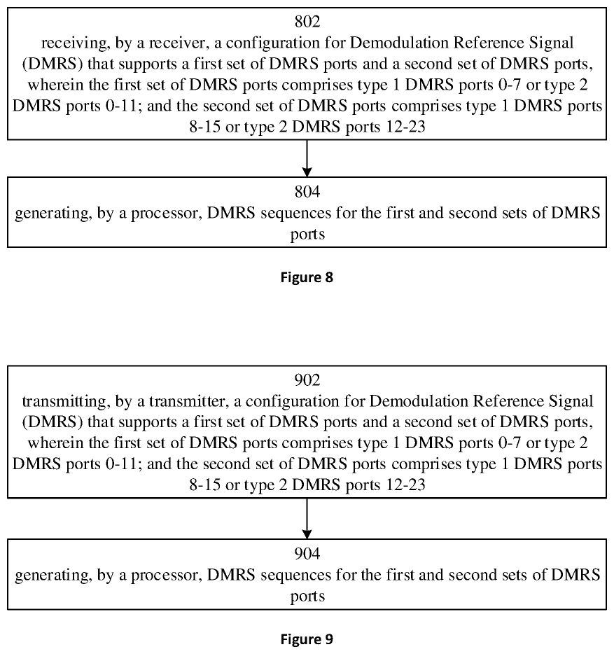

FIG. 8 is a flow chart illustrating steps of DMRS sequence generation by UE 200 in accordance with some implementations of the present disclosure.

At step 802, the receiver 214 of UE 200 receives a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23.

At step 804, the processor 202 of UE 200 generates DMRS sequences for the first and second sets of DMRS ports.

FIG. 9 is a flow chart illustrating steps of DMRS sequence generation by gNB 300 in accordance with some implementations of the present disclosure.

At step 902, the transmitter 312 of gNB 200 transmits a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23.

At step 904, the processor 302 of gNB 300 generates DMRS sequences for the first and second sets of DMRS ports.

In one aspect, some items as examples of the disclosure concerning UE for DMRS sequence generation may be summarized as follows:

1. An apparatus, comprising:

a receiver that receives a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23;

a processor that generates DMRS sequences for the first and second sets of DMRS ports.

2. The apparatus of item 1, wherein the receiver further receives a configuration for enabling low Peak-to-Average Power Ratio (PAPR) DMRS sequence.

3. The apparatus of item 1, wherein the first set of DMRS ports are from a first set of Code-Division Multiplexing (CDM) groups, and the second set of DMRS ports are grouped into the first set of CDM groups; and the processor generates two DMRS sequences for each CDM group in the first set of CDM groups.

4. The apparatus of item 3, wherein the two DMRS sequences for a CDM group comprise:

a first DMRS sequence, based on a first initialization value, for the first set of DMRS ports within the CDM group; and

a second DMRS sequence, based on a second initialization value, for the second set of DMRS ports within the CDM group.

5. The apparatus of item 4, wherein the first initialization value is derived based on a predefined formula, and the second initialization value is derived based on the predefined formula with an offset value.

6. The apparatus of item 3, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

7. The apparatus of item 3, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

8. The apparatus of item 1, wherein the first set of DMRS ports are from a first set of CDM groups, and the second set of DMRS ports are grouped into a second set of CDM groups; and the processor generates an additional DMRS sequence for each CDM group in the second set of CDM groups, different from a corresponding DMRS sequence in the first set of CDM groups.

9. The apparatus of item 8, wherein the DMRS is type 1 DMRS where the second set of CDM groups comprises CDM group 2 and CDM group 3; CDM group 2 includes DMRS ports 8, 9, 12, 13; and CDM group 3 includes DMRS ports 10, 11, 14, 15.

10. The apparatus of item 8, wherein the DMRS is type 2 DMRS where the second set of CDM groups comprises CDM group 3, CDM group 4, and CDM group 5; CDM group 3 includes DMRS ports 12, 13, 18, 19; CDM group 4 includes DMRS ports 14, 15, 20, 21; and CDM group 5 includes DMRS ports 16, 17, 22, 23.

11. The apparatus of item 1, wherein the first set of DMRS ports are from a first set of CDM groups, and the second set of DMRS ports are grouped into the first set of CDM groups; and the processor generates one sequence r(m) for all DMRS ports in each CDM group in the first set of CDM groups, where m is a list of nonnegative integers starting from zero.

12. The apparatus of item 11, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

13. The apparatus of item 11, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

14. The apparatus of item 11, wherein the sequence r(m) has a first half being the DMRS sequence for DMRS ports of the CDM group in the first set of DMRS ports, and a second half being the DMRS sequence for DMRS ports of the CDM group in the second set of DMRS ports.

15. The apparatus of item 14, wherein the first half of the sequence is r(4n+k′); and the second half of the sequence is r(4n+k′+2), where k′is 0 and 1, and n is a list of nonnegative integers starting from zero.

In another aspect, some items as examples of the disclosure concerning gNB for DMRS sequence generation may be summarized as follows:

16. An apparatus, comprising:

a transmitter that transmits a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23;

a processor that generates DMRS sequences for the first and second sets of DMRS ports.

17. The apparatus of item 16, wherein the transmitter further transmits a configuration for enabling low Peak-to-Average Power Ratio (PAPR) DMRS sequence.

18. The apparatus of item 16, wherein the first set of DMRS ports are from a first set of Code-Division Multiplexing (CDM) groups, and the second set of DMRS ports are grouped into the first set of CDM groups; and the processor generates two DMRS sequences for each CDM group in the first set of CDM groups.

19. The apparatus of item 18, wherein the two DMRS sequences for a CDM group comprise:

a first DMRS sequence, based on a first initialization value, for the first set of DMRS ports within the CDM group; and

a second DMRS sequence, based on a second initialization value, for the second set of DMRS ports within the CDM group.

20. The apparatus of item 19, wherein the first initialization value is derived based on a predefined formula, and the second initialization value is derived based on the predefined formula with an offset value.

21. The apparatus of item 18, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

22. The apparatus of item 18, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

23. The apparatus of item 16, wherein the first set of DMRS ports are from a first set of CDM groups, and the second set of DMRS ports are grouped into a second set of CDM groups; and the processor generates an additional DMRS sequence for each CDM group in the second set of CDM groups, different from a corresponding DMRS sequence in the first set of CDM groups.

24. The apparatus of item 23, wherein the DMRS is type 1 DMRS where the second set of CDM groups comprises CDM group 2 and CDM group 3; CDM group 2 includes DMRS ports 8, 9, 12, 13; and CDM group 3 includes DMRS ports 10, 11, 14, 15.

25. The apparatus of item 23, wherein the DMRS is type 2 DMRS where the second set of CDM groups comprises CDM group 3, CDM group 4, and CDM group 5; CDM group 3 includes DMRS ports 12, 13, 18, 19; CDM group 4 includes DMRS ports 14, 15, 20, 21; and CDM group 5 includes DMRS ports 16, 17, 22, 23.

26. The apparatus of item 16, wherein the first set of DMRS ports are from a first set of CDM groups, and the second set of DMRS ports are grouped into the first set of CDM groups; and the processor generates one sequence r(m) for all DMRS ports in each CDM group in the first set of CDM groups, where m is a list of nonnegative integers starting from zero.

27. The apparatus of item 26, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

28. The apparatus of item 26, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

29. The apparatus of item 26, wherein the sequence r(m) has a first half being the DMRS sequence for DMRS ports of the CDM group in the first set of DMRS ports, and a second half being the DMRS sequence for DMRS ports of the CDM group in the second set of DMRS ports.

30. The apparatus of item 29, wherein the first half of the sequence is r(4n+k′); and the second half of the sequence is r(4n+k′+2), where k′ is 0 and 1, and n is a list of nonnegative integers starting from zero.

In a further aspect, some items as examples of the disclosure concerning a method of DMRS sequence generation by UE may be summarized as follows:

31. A method, comprising:

receiving, by a receiver, a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23;

generating, by a processor, DMRS sequences for the first and second sets of DMRS ports.

32. The method of item 31, wherein the receiver further receives a configuration for enabling low Peak-to-Average Power Ratio (PAPR) DMRS sequence.

33. The method of item 31, wherein the first set of DMRS ports are from a first set of Code-Division Multiplexing (CDM) groups, and the second set of DMRS ports are grouped into the first set of CDM groups; and the processor generates two DMRS sequences for each CDM group in the first set of CDM groups.

34. The method of item 33, wherein the two DMRS sequences for a CDM group comprise:

a first DMRS sequence, based on a first initialization value, for the first set of DMRS ports within the CDM group; and

a second DMRS sequence, based on a second initialization value, for the second set of DMRS ports within the CDM group.

35. The method of item 34, wherein the first initialization value is derived based on a predefined formula, and the second initialization value is derived based on the predefined formula with an offset value.

36. The method of item 33, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

37. The method of item 33, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

38. The method of item 31, wherein the first set of DMRS ports are from a first set of CDM groups, and the second set of DMRS ports are grouped into a second set of CDM groups; and the processor generates an additional DMRS sequence for each CDM group in the second set of CDM groups, different from a corresponding DMRS sequence in the first set of CDM groups.

39. The method of item 38, wherein the DMRS is type 1 DMRS where the second set of CDM groups comprises CDM group 2 and CDM group 3; CDM group 2 includes DMRS ports 8, 9, 12, 13; and CDM group 3 includes DMRS ports 10, 11, 14, 15.

40. The method of item 38, wherein the DMRS is type 2 DMRS where the second set of CDM groups comprises CDM group 3, CDM group 4, and CDM group 5; CDM group 3 includes DMRS ports 12, 13, 18, 19; CDM group 4 includes DMRS ports 14, 15, 20, 21; and CDM group 5 includes DMRS ports 16, 17, 22, 23.

41. The method of item 31, wherein the first set of DMRS ports are from a first set of CDM groups, and the second set of DMRS ports are grouped into the first set of CDM groups; and the processor generates one sequence r(m) for all DMRS ports in each CDM group in the first set of CDM groups, where m is a list of nonnegative integers starting from zero.

42. The method of item 41, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

43. The method of item 41, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

44. The method of item 41, wherein the sequence r(m) has a first half being the DMRS sequence for DMRS ports of the CDM group in the first set of DMRS ports, and a second half being the DMRS sequence for DMRS ports of the CDM group in the second set of DMRS ports.

45. The method of item 44, wherein the first half of the sequence is r(4n+k′); and the second half of the sequence is r(4n+k′+2), where k′ is 0 and 1, and n is a list of nonnegative integers starting from zero.

In a yet further aspect, some items as examples of the disclosure concerning a method of DMRS sequence generation by gNB may be summarized as follows:

46. A method, comprising:

transmitting, by a transmitter, a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23;

generating, by a processor, DMRS sequences for the first and second sets of DMRS ports.

47. The method of item 46, wherein the transmitter further transmits a configuration for enabling low Peak-to-Average Power Ratio (PAPR) DMRS sequence.

48. The method of item 46, wherein the first set of DMRS ports are from a first set of Code-Division Multiplexing (CDM) groups, and the second set of DMRS ports are grouped into the first set of CDM groups; and the processor generates two DMRS sequences for each CDM group in the first set of CDM groups.

49. The method of item 48, wherein the two DMRS sequences for a CDM group comprise:

a first DMRS sequence, based on a first initialization value, for the first set of DMRS ports within the CDM group; and

a second DMRS sequence, based on a second initialization value, for the second set of DMRS ports within the CDM group.

50. The method of item 49, wherein the first initialization value is derived based on a predefined formula, and the second initialization value is derived based on the predefined formula with an offset value.

51. The method of item 48, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

52. The method of item 48, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

53. The method of item 46, wherein the first set of DMRS ports are from a first set of CDM groups, and the second set of DMRS ports are grouped into a second set of CDM groups; and the processor generates an additional DMRS sequence for each CDM group in the second set of CDM groups, different from a corresponding DMRS sequence in the first set of CDM groups.

54. The method of item 53, wherein the DMRS is type 1 DMRS where the second set of CDM groups comprises CDM group 2 and CDM group 3; CDM group 2 includes DMRS ports 8, 9, 12, 13; and CDM group 3 includes DMRS ports 10, 11, 14, 15.

55. The method of item 53, wherein the DMRS is type 2 DMRS where the second set of CDM groups comprises CDM group 3, CDM group 4, and CDM group 5; CDM group 3 includes DMRS ports 12, 13, 18, 19; CDM group 4 includes DMRS ports 14, 15, 20, 21; and CDM group 5 includes DMRS ports 16, 17, 22, 23.

56. The method of item 46, wherein the first set of DMRS ports are from a first set of CDM groups, and the second set of DMRS ports are grouped into the first set of CDM groups; and the processor generates one sequence r(m) for all DMRS ports in each CDM group in the first set of CDM groups, where m is a list of nonnegative integers starting from zero.

57. The method of item 56, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

58. The method of item 56, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

59. The method of item 56, wherein the sequence r(m) has a first half being the DMRS sequence for DMRS ports of the CDM group in the first set of DMRS ports, and a second half being the DMRS sequence for DMRS ports of the CDM group in the second set of DMRS ports.

60. The method of item 59, wherein the first half of the sequence is r(4n+k′); and the second half of the sequence is r(4n+k′+2), where k′ is 0 and 1, and n is a list of nonnegative integers starting from zero.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and
generate DMRS sequences for the first and second sets of DMRS ports.

2. The UE of claim 1, wherein the at least one processor is configured to cause the UE to receive a configuration for enabling low Peak-to-Average Power Ratio (PAPR) DMRS sequence.

3. The UE of claim 1, wherein the first set of DMRS ports are from a first set of Code-Division Multiplexing (CDM) groups, and the second set of DMRS ports are grouped into the first set of CDM groups; and the at least one processor is configured to cause the UE to generate two DMRS sequences for each CDM group in the first set of CDM groups.

4. The UE of claim 3, wherein the two DMRS sequences for a CDM group comprise:
a first DMRS sequence, based on a first initialization value, for the first set of DMRS ports within the CDM group; and
a second DMRS sequence, based on a second initialization value, for the second set of DMRS ports within the CDM group;
wherein the first initialization value is derived based on a predefined formula, and the second initialization value is derived based on the predefined formula with an offset value.

5. The UE of claim 3, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.

6. The UE of claim 3, wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

7. The UE of claim 1, wherein the first set of DMRS ports are from a first set of CDM groups, and the second set of DMRS ports are grouped into a second set of CDM groups; and the at least one processor is configured to cause the UE to generate an additional DMRS sequence for each CDM group in the second set of CDM groups, different from a corresponding DMRS sequence in the first set of CDM groups.

8. The UE of claim 7, wherein the DMRS is type 1 DMRS where the second set of CDM groups comprises CDM group 2 and CDM group 3;
CDM group 2 includes DMRS ports 8, 9, 12, 13; and CDM group 3 includes DMRS ports 10, 11, 14, 15.

9. The UE of claim 7, wherein the DMRS is type 2 DMRS where the second set of CDM groups comprises CDM group 3, CDM group 4, and CDM group 5; CDM group 3 includes DMRS ports 12, 13, 18, 19; CDM group 4 includes DMRS ports 14, 15, 20, 21; and CDM group 5 includes DMRS ports 16, 17, 22, 23.

10. The UE of claim 1, wherein the first set of DMRS ports are from a first set of CDM groups, and the second set of DMRS ports are grouped into the first set of CDM groups; and the at least one processor is configured to cause the Ue to generate one sequence r(m) for all DMRS ports in each CDM group in the first set of CDM groups, where m is a list of nonnegative integers starting from zero.

11. The UE of claim 10, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15; and wherein for DMRS type 2, the first set of CDM groups comprises CDM group 0, CDM group 1 and CDM group 2, where CDM group 0 includes DMRS ports 0, 1, 6, 7, 12, 13, 18, 19; CDM group 1 includes DMRS ports 2, 3, 8, 9, 14, 15, 20, 21; and CDM group 2 includes DMRS ports 4, 5, 10, 11, 16, 17, 22, 23.

12. The UE of claim 10, wherein the sequence r(m) has a first half being the DMRS sequence for DMRS ports of the CDM group in the first set of DMRS ports, and a second half being the DMRS sequence for DMRS ports of the CDM group in the second set of DMRS ports.

13. The UE of claim 12, wherein the first half of the sequence is r(4n+k′); and the second half of the sequence is r(4n+k′+2), where k′ is 0 and 1, and n is a list of nonnegative integers starting from zero.

14. A base station, comprising:
at least one memory; and
at least one processor coupled with the at least one memory and configured to cause the base station to:
transmit a configuration for Demodulation Reference Signal (DMRS) that supports a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and
generate DMRS sequences for the first and second sets of DMRS ports.

15. A method performed by a user equipment (UE), the method comprising:
receiving a configuration for Demodulation Reference Signal (DMRS) that supports a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and
generating DMRS sequences for the first and second sets of DMRS ports.

16. A processor for wireless communication, comprising:
at least one controller coupled with at least one memory and configured to cause the processor to:
receive a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and
generate DMRS sequences for the first and second sets of DMRS ports.

17. The processor of claim 16, wherein the at least one controller is configured to cause the processor to receive a configuration for enabling low Peak-to-Average Power Ratio (PAPR) DMRS sequence.

18. The processor of claim 16, wherein the first set of DMRS ports are from a first set of Code-Division Multiplexing (CDM) groups, and the second set of DMRS ports are grouped into the first set of CDM groups; and the at least one controller is configured to cause the processor to generate two DMRS sequences for each CDM group in the first set of CDM groups.

19. The processor of claim 18, wherein the two DMRS sequences for a CDM group comprise:
a first DMRS sequence, based on a first initialization value, for the first set of DMRS ports within the CDM group; and
a second DMRS sequence, based on a second initialization value, for the second set of DMRS ports within the CDM group;
wherein the first initialization value is derived based on a predefined formula, and the second initialization value is derived based on the predefined formula with an offset value.

20. The processor of claim 18, wherein for DMRS type 1, the first set of CDM groups comprises CDM group 0 and CDM group 1, where CDM group 0 includes DMRS ports 0, 1, 4, 5, 8, 9, 12, 13; and CDM group 1 includes DMRS ports 2, 3, 6, 7, 10, 11, 14, 15.
